(19) United States
(12) Patent Application Publication
(10) Pub. No.: US 2025/0158794 A1
(43) Pub. Date: May 15, 2025

(54) REDUCING CROSSTALK ON DUPLEX SIGNAL COMMUNICATION CHANNELS

(71) Applicant: International Business Machines Corporation, Armonk, NY (US)

(72) Inventors: Layne A. Berge, Rochester, MN (US); Matthew Doyle, Chatfield, MN (US); Kyle Schoneck, Rochester, MN (US); Jason J. Bjorgaard, ROCHESTER, MN (US); John R. Dangler, ROCHESTER, MN (US); Matthew A. Walther, ROCHESTER, MN (US); Kevin Daniel Escobar, ROCHESTER, MN (US); Thomas W. Liang, ROCHESTER, MN (US)

(21) Appl. No.: 18/505,431

(22) Filed: Nov. 9, 2023

(51) Int. Cl. H04L 5/14

(52) U.S. Cl. CPC H04L 5/14

(57) ABSTRACT

A duplex signal communication channel includes first and second signal transmission lines. While a first amplifier coupled to the first signal transmission line is driver into a nonlinear region of operation, a first data signal is transmitted by the first amplifier on the first signal transmission line. The first data signal is transmitted at a multiple of a common clock frequency. A second amplifier coupled to the second signal transmission line transmits a second data signal on the second signal transmission line concurrently with the first data signal, but does so at the common clock frequency. A first receiver circuit receives the first data signal on the first signal transmission line, and a second receiver circuit receives the second data signal on the second signal transmission line. Receiving the first data signal includes extracting the first data signal from the first signal transmission line utilizing a frequency divider circuit.

### BACKGROUND OF THE INVENTION

This disclosure relates to data communication, and in particular, to reducing crosstalk on duplex signal communication channels.

In data processing and data communication environments, data is communicated among different components (e.g., integrated circuits) via various signal communication channels. In a typical embodiment, a duplex signal communication channel includes a first signal transmission line for transmitting data from a first unit (e.g., a first integrated circuit) to a second unit (e.g., a second integrated circuit) and a paired second signal transmission line for transmitting data from the second unit to the first unit.

A common issue with duplex signal communication channels is unwanted crosstalk between the signal transmission lines. In the prior art, different strategies are employed to reduce or eliminate crosstalk between signal transmission lines and the associated effects of crosstalk. For example, in a first strategy, different frequencies are utilized to communicate data on different ones of the paired signal transmission lines. While this is an effective solution, implementing different frequencies on the paired signal transmission lines of the duplex signal communication channel can make circuit design more complex in that multiple different clock signals often must be generated, distributed, and synchronized. A second strategy for reducing crosstalk in duplex signal communication channels is to implement time-based multiplexing, which schedules transmission of data on the paired signal transmission lines at different times. While this second strategy is effective in eliminating crosstalk, time-based multiplexing results in an undesirable 50% reduction in the bandwidth of the duplex signal communication channel. A third strategy, generally referred to as simultaneous transmit and receive, allows simultaneous data communication on the paired signal transmission lines at a common frequency. However, this capability comes at the tradeoff of complex and expensive circuitry to cancel crosstalk between the paired signal transmission lines, for example, utilizing a feed-forward circuit topology.

### BRIEF SUMMARY

In view of the foregoing, the present application appreciates that it would be useful and desirable to provide improved techniques for reducing or eliminating crosstalk between the paired signal transmission lines of a duplex signal communication channel that enable simultaneous transmission and receipt of data on the paired signal transmission lines utilizing a common frequency, but that do so without introducing significant circuit complexity.

In one or more embodiments, a duplex signal communication channel includes first and second signal transmission lines. While a first amplifier coupled to the first signal transmission line is driver into a nonlinear region of operation, a first data signal is transmitted by the first amplifier on the first signal transmission line. The first data signal is transmitted at a multiple of a common clock frequency. A second amplifier coupled to the second signal transmission line transmits a second data signal on the second signal transmission line concurrently with the first data signal, but does so at the common clock frequency. A first receiver circuit receives the first data signal on the first signal transmission line, and a second receiver circuit receives the second data signal on the second signal transmission line. Receiving the first data signal includes extracting the first data signal from the first signal transmission line utilizing a frequency divider circuit.

In some embodiments, the first amplifier and the second receiver circuit form a portion of a first integrated circuit.

In some embodiments, the first and second signal transmission lines comprise metal traces on a printed circuit board.

In some embodiments, the duplex communication channel forms a portion of a cable.

In some embodiments, the common clock frequency is in the radio-frequency (RF) range.

In some embodiments, the frequency multiple can be 2.

In some embodiments, the duplex signal communication channel can be implemented within a data processing system including a processor communicatively coupled to the duplex signal communication channel.

In some embodiments, a method of communication duplex signal communication channel can be embodied within a data processing system including a processor communicatively coupled to the duplex signal communication channel.

In some embodiments, a method of data communication utilizes a duplex signal communication channel including first and second signal transmission lines. According to the method, a first amplifier coupled to the first signal transmission line is driven into a nonlinear region of operation. While in the nonlinear region, the first amplifier transmits a first data signal on the first signal transmission line. The first data signal is transmitted at a multiple of a common clock frequency, wherein the multiple is greater than 1. Concurrently with transmission of the first data signal, a second amplifier transmits a second data signal on the second signal transmission line at the common clock frequency. A first receiver circuit receives the first data signal from the first signal transmission line. Receiving the first data signal includes extracting the first data signal from the first signal transmission line utilizing a frequency divider circuit. A second receiver circuit receives the second data signal on the second signal transmission line.

### BRIEF DESCRIPTION OF THE SEVERAL VIEWS OF THE DRAWINGS

FIG. 1 is a high-level block diagram of an exemplary high-performance computing environment in accordance with one or more embodiments;

FIG. 2 is a block diagram of an exemplary duplex signal communication channel in accordance with one or more embodiments;

FIG. 3 is a frequency diagram of communication on a duplex signal communication channel in accordance with one more embodiments;

FIG. 4 is a high-level logical flowchart of an exemplary process for communicating data on a duplex signal communication channel in accordance with one or more embodiments; and

FIG. 5 is a more detailed block diagram of an exemplary embodiment of a frequency divider circuit in accordance with one or more embodiments.

### DETAILED DESCRIPTION

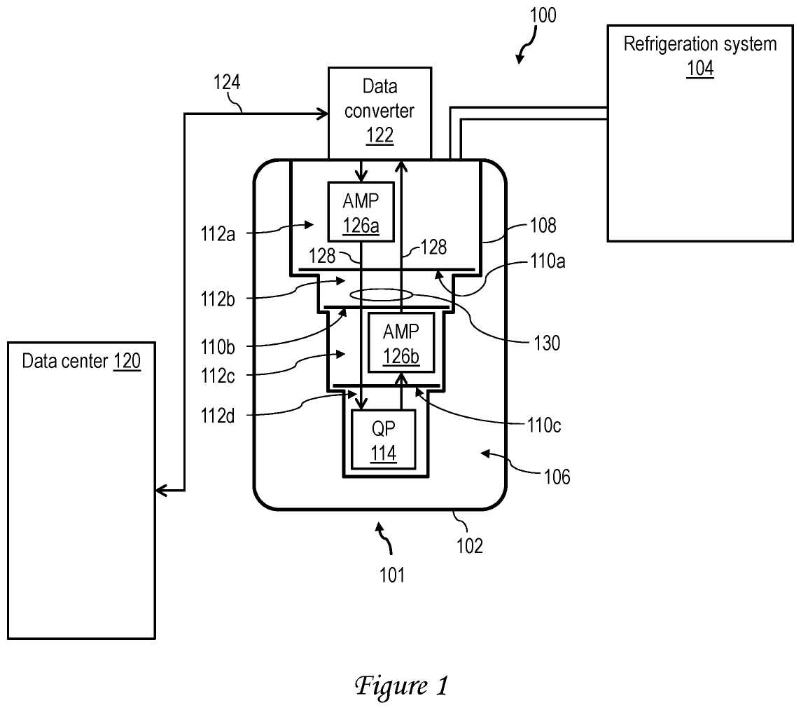

With reference now to the figures and with particular reference to FIG. 1, there is illustrated a high-level block diagram of an exemplary high-performance computing environment 100 in accordance with one or more embodiments. In this example, high-performance computing environment 100 is illustrated as being a quantum computing environment; of course, in other examples, high-performance computing environment 100 can be a classical computing environment, such as a supercomputer, mainframe, or data center computing environment.

In FIG. 1, high-performance computing environment 100 includes a quantum computer 101. Quantum computer 101 includes an outer temperature control vessel 102, which preferably includes or provides electromagnetic shielding. A refrigeration system 104 preferably maintains interior volume 106 of temperature control vessel 102 at a selected temperature between, for example, 273° K and 325° K. Temperature control vessel 102 houses a vacuum vessel 108 having an interior volume maintained at near vacuum. The interior volume of vacuum vessel 108 is divided by plates or partitions 110a, 110b, and 110c into a plurality of temperature zones 112a, 112b, 112c, and 112d maintained at progressively lower temperatures by refrigeration system 104. For example, temperature zone 112a may be maintained at about 50° K, temperature zone 112b may be maintained at about 25° K, temperature zone 112c may be maintained at about 5° K, and temperature zone 112d may be maintained at a few tenths or hundredths of a degree from absolute zero (e.g., 0.01° K). A quantum processor (QP) 114 disposed in temperature zone 112d performs data processing based on the states of a plurality of qubits.

High-performance computing environment 100 additionally includes a data center 120 that prepares workloads for processing by quantum computer 101 and processes the data output produced by quantum computer 114. Data center 120 is communicatively coupled, via one or more data networks 124, to a data converter 122 associated with quantum computer 101. Data converter 122 converts digital data received from data center 120 via data network 124 into analog format for processing by quantum processor 114 and converts analog data produced by quantum processor 114 into digital data for transmission to data center 120 via data network 124. Quantum computer 101 can additionally include amplifiers 126a, 126b to amplify the analog signals transmitted between data converter 122 and quantum processor 114 via signal transmission lines 128.

Although FIG. 1 explicitly illustrates only a single pair of signal transmission lines 128 forming a duplex signal communication channel 130, those skilled in the art will appreciate that in commercial implementations high-performance computing environment 100 would typically include multiple of such duplex signal communication channels 130. Further, it should be understood that the disclosed inventions are not limited in application to high-performance computing environments, but are instead applicable to other environments, such as commercial computing environments, consumer electronics, avionics, automotive computing environments, etc.

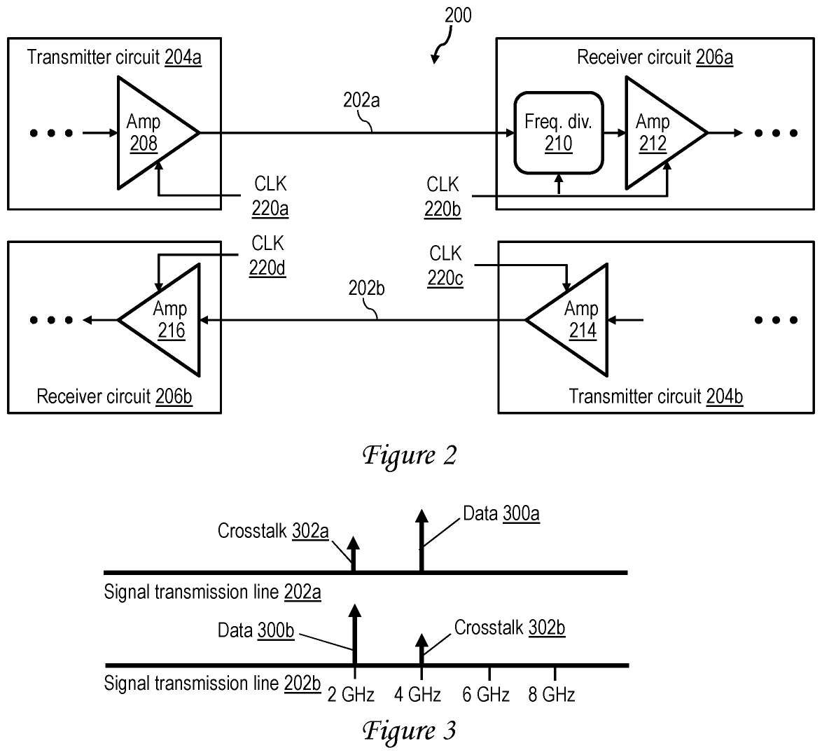

Referring now to FIG. 2, there is depicted a block diagram of an exemplary duplex signal communication channel 200 in accordance with one or more embodiments. Duplex signal communication channel 200 can be utilized, for example, to implement duplex communication channel 130 of FIG. 1.

In the illustrated embodiment, duplex signal communication channel 200 includes a first signal transmission line 202a for conveying data from a first transmitter circuit 204a to a first receiver circuit 206a. First transmitter circuit 204a includes, among other circuit components, an amplifier (or driver) 208, and first receiver circuit 206a includes a frequency divider 210 coupled to an amplifier 212. Duplex signal communication channel 200 additionally includes a second signal transmission line 202b for conveying data from a second transmitter circuit 204b to second receiver circuit 206b. Second transmitter circuit 204b includes, among other circuit components, an amplifier (or driver) 214, and second receiver circuit 206b includes an amplifier 216.

In some implementations, transmitter circuit 204a and receiver circuit 206b may be realized within a first integrated circuit, and transmitter circuit 204b and receiver circuit 206a can be realized within a different second integrated circuit. In some of these implementations, transmitter circuit 204a and receiver circuit 206 may together form part of a first serializer/deserializer (SERDES) block, and transmitter circuit 204b and receiver circuit 206a can together form part of a second SERDES block. In some implementations, signal transmission lines 202a, 202b may be implemented as metal traces on a printed circuit board (PCB), while in other cases signal transmission lines 202a, 202b may be implemented within a cable or other interconnect. Further, in some implementations, multiple duplex signal communication channels 200 can be implemented in parallel. It should also be noted that amplifiers 208 and 214 may be configured to apply differing amplification to data signals. For example, in some implementations, the amplification applied by amplifier 208 may be 10 or 100 dB greater than that applied by amplifier 214.

As illustrated, amplifiers 208, 212, 214, and 216 and frequency divider 210 all operate in response to one or more clock signal(s) 220 (in this case, CLK signals 220a-220d) all having a common clock frequency. As a result, crosstalk inductively coupled between first and second signal transmission lines 202a, 202b can be a concern if not appropriately addressed.

In accordance with preferred embodiments, the effects of crosstalk between the signal transmission lines of a duplex signal communication channel are reduced by communicating the relevant portions of the data signals on the different signal transmission lines at different frequencies. FIG. 3 is a frequency diagram of communication on duplex signal communication channel 200 of FIG. 2 in accordance with one more embodiments. In these embodiments, at least amplifier 208 is driven to operate in its non-linear region, preferably at or near saturation. While operating in the non-linear region, the data signal output by amplifier 208 can be generally described as having the form:

$$D = a * {f}_{1} + b * {f}_{2} + c * {f}_{3} + … ,$$

where f₁, f₂, and f₃ are differing frequency multiples, and a, b, and c are coefficients expressing signal amplitudes at the various frequencies. In the specific example shown in FIG. 3, f₁ is 2 GHz, f₂ is 4 GHZ, and higher frequency components of the data signal are not explicitly illustrated. Of course, in other embodiments, frequencies f₁ and f₂ need not be integer frequencies and need not be related as integer multiples (e.g., integer powers of 2).

The effects of crosstalk in duplex signal communication channel 200 are ameliorated by communicating the relevant content of the data signal on each of signal transmission lines 202a, 202b at a different frequency. Thus, for example, the data signal 300a on signal transmission line 202a can be transmitted at 4 GHZ, and the data signal 300b on signal transmission line 202b can be transmitted at 2 GHz. Consequently, the crosstalk 302b induced on signal transmission line 202b by data signal 300a does not interfere with data signal 300b, and the crosstalk 302a induced on signal transmission line 202a by data signal 300b does not interfere with data signal 300a, even though a common clock frequency is employed.

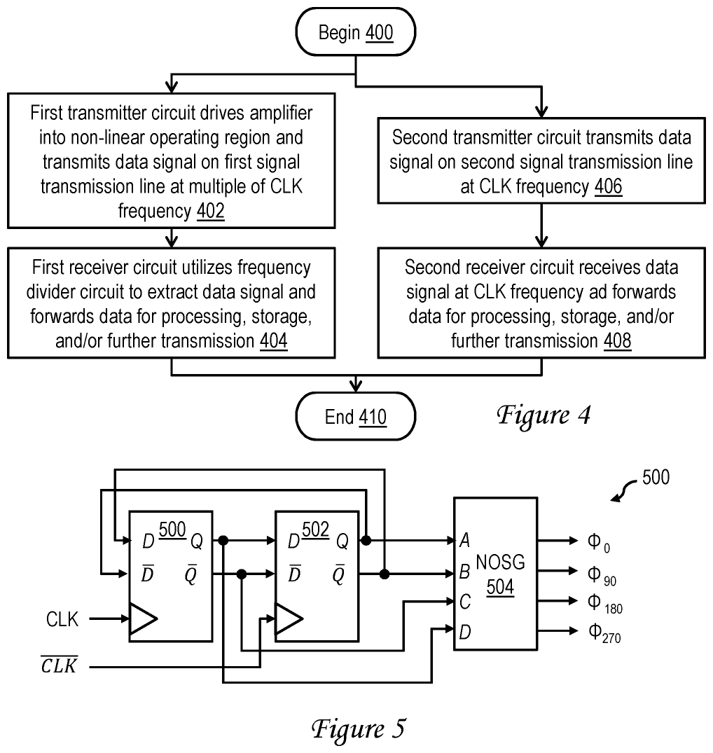

Referring now to FIG. 4, there is depicted a high-level logical flowchart of an exemplary process for communicating data on a duplex signal communication channel 200 in accordance with one or more embodiments. For ease of understanding, the process is described with reference to the exemplary embodiment given in FIG. 2.

The process of FIG. 4 begins at block 400 and then proceeds in parallel along a first path (including blocks 402 and 404) representing the processing for communicating a data signal on first signal transmission line 202a and along a second path (including blocks 406 and 408) representing the processing for communicating a data signal on second signal transmission line 202b. FIG. 4 thus illustrates that data signals can be (but are not required to be) simultaneously transmitted and received on signal transmission lines 202a, 202b.

Referring first to block 402, first transmitter circuit 204a drives amplifier 208 into its non-linear operating region and utilizes amplifier 208 to transmit a signal on signal transmission line 202a, with the data content of the signal being transmitted at a multiple of the common clock frequency utilized to time the operation of amplifiers 208 and 214. Thus, in the example of FIG. 3, the data signal 300a is communicated on signal transmission line 202a at 4 GHz rather than the 2 GHz frequency of CLK signal(s) 220. As depicted at block 404, first receiver circuit 206a receives the data signal on first signal transmission line 202a and extracts the data utilizing a frequency divider circuit 210. An exemplary embodiment of frequency divider circuit is described in greater detail below with reference to FIG. 5. Following extraction of the data signal, amplifier 212 of first receiver circuit 206a can forward the data to other circuitry for processing, storage, and/or further transmission.

Referring now to block 406, second transmitter circuit 204a utilizes amplifier 214 to transmit a data signal on signal transmission line 202b at the common clock frequency utilized to time the operation of amplifiers 208 and 214. Thus, in the example of FIG. 3, the data signal 300b is communicated on signal transmission line 202b at the 2 GHz frequency of CLK signal(s) 220. As depicted at block 408, second receiver circuit 206b receives the data signal on signal transmission line 202b, and an amplifier 216 of second receiver circuit 206a can forward the data to other circuitry for processing, storage, and/or further transmission. Following blocks 404 and 408, the process of FIG. 4 ends at block 410.

Referring now to FIG. 5, there is illustrated a more detailed block diagram of an exemplary embodiment of a frequency divider circuit 500 in accordance with one or more embodiments. Frequency divider circuit 500, which can be utilized to implement frequency divider circuit 210 of FIG. 2, has a design suitable for low-power radio frequency (RF) applications.

In the example depicted in FIG. 5, frequency divider circuit 500 includes cross-coupled D-latches 500 and 502 and a non-overlapping signal generator (NOSG) 504. Each of D-latches 500 and 502 has a D input, D̅ input, and a clock input, as well as Q and Q̅ outputs. The D and D̅ inputs of D-latch 500 are coupled to the Q̅ and Q outputs, respectively, of D-latch 502. The D and D̅ inputs of D-latch 502 are coupled to the Q and Q̅ outputs, respectively, of D-latch 500. The clock input of D-latch 500 is coupled to receive the data signal from signal transmission line 202a, and the clock input of D-latch 502 is coupled to receive the inverted data signal.

Non-overlapping signal generator 504 includes four inputs labeled A, B, C and D, each feeding a respective one of four non-overlapping signal outputs labeled as Φ₀, Φ₉₀, Φ₁₈₀, Φ₂₇₀. Inputs A and B of non-overlapping signal generator 504 are coupled to the Q and Q̅ outputs, respectively, of D-latch 502, and inputs C and D of non-overlapping signal generator 504 are coupled to the Q̅ and Q outputs, respectively, of D-latch 500. Non-overlapping signal generator 504 is configured, for example, utilizing a cascade of NAND gates, to assert only one of signal outputs Φ₀, Φ₉₀, Φ₁₈₀, Φ₂₇₀ at a time, providing an output with a duty cycle that is 25% of the input data signal. Those skilled in the art will appreciate that the disclosed arrangement can be modified to provide other desired divisions of the frequency of the input data signal (e.g., divide by 2).

As has been described, in at least one embodiment, a duplex signal communication channel includes first and second signal transmission lines. While a first amplifier coupled to the first signal transmission line is driver into a nonlinear region of operation, a first data signal is transmitted by the first amplifier on the first signal transmission line. The first data signal is transmitted at a multiple of a common clock frequency. A second amplifier coupled to the second signal transmission line transmits a second data signal on the second signal transmission line concurrently with the first data signal, but does so at the common clock frequency. A first receiver circuit receives the first data signal on the first signal transmission line, and a second receiver circuit receives the second data signal on the second signal transmission line. Receiving the first data signal includes extracting the first data signal from the first signal transmission line utilizing a frequency divider circuit.

In some embodiments, the first amplifier and the second receiver circuit form a portion of a first integrated circuit.

In some embodiments, the first and second signal transmission lines comprise metal traces on a printed circuit board.

In some embodiments, the duplex communication channel forms a portion of a cable.

In some embodiments, the common clock frequency is in the radio-frequency (RF) range.

In some embodiments, the frequency multiple can be 2.

In some embodiments, the duplex signal communication channel can be implemented within a data processing system including a processor communicatively coupled to the duplex signal communication channel.

In some embodiments, a method of communication duplex signal communication channel can be embodied within a data processing system including a processor communicatively coupled to the duplex signal communication channel.

In some embodiments, a method of data communication utilizes a duplex signal communication channel including first and second signal transmission lines. According to the method, a first amplifier coupled to the first signal transmission line is driven into a nonlinear region of operation. While in the nonlinear region, the first amplifier transmits a first data signal on the first signal transmission line. The first data signal is transmitted at a multiple of a common clock frequency, wherein the multiple is greater than 1. Concurrently with transmission of the first data signal, a second amplifier transmits a second data signal on the second signal transmission line at the common clock frequency. A first receiver circuit receives the first data signal from the first signal transmission line. Receiving the first data signal includes extracting the first data signal from the first signal transmission line utilizing a frequency divider circuit. A second receiver circuit receives the second data signal on the second signal transmission line.

The disclosed inventions harness utilization of the non-linear characteristic of an amplifier and frequency domain multiplexing to reduce the effects of crosstalk on a duplex signal communication channel. The disclosed inventions simplify the circuitry supporting simultaneous transmission and reception of data via duplex signal communication channels, enabling circuitry density improvements. The reduction in crosstalk also raises the allowable channel attenuation budget and supports reduction in the power budget for data communication.

While various embodiments have been particularly shown and described, it will be understood by those skilled in the art that various changes in form and detail may be made therein without departing from the spirit and scope of the appended claims and these alternate implementations all fall within the scope of the appended claims. For example, those skilled in the art should appreciate that the capacitive coupling between abutting segments of the thermally decoupled signal transmission lines can be tuned through use of a high permittivity dielectric and/or with changes in the geometry of the joints. For example, in some embodiments, the capacitance between the abutting surfaces can be increased by reducing the distance between signal conductors at the abutting surfaces or by increasing the coupled surface area through enlargement of the ends of the conductors or implementation of more advanced conductor shapes (e.g., inter-digitation of the conductors of abutting segments).

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that features of different disclosed embodiments can be combined. Lastly, the use of a singular term, such as, but not limited to, “a” is not intended as limiting of the number of items.

What is claimed is:

1. A duplex signal communication channel, comprising:
first and second signal transmission lines;
a first amplifier and a first receiver circuit coupled by the first signal transmission line;
a second amplifier and a second receiver circuit coupled by the second signal transmission line;
wherein:
the first amplifier is operative in a nonlinear operation region to transmit a first data signal on the first signal transmission line at a multiple of a common clock frequency, wherein the multiple is greater than 1;
the second amplifier is operative to transmit a second data signal on the second signal transmission line at the common clock frequency concurrently with transmission of the first data signal;
the first receiver circuit includes a frequency divider circuit operative to extract the first data signal from the first signal transmission line; and
the second receiver circuit is operative to receive the second data signal on the second signal transmission line.

2. The duplex signal communication channel of claim 1, wherein the first amplifier and the second receiver circuit form a portion of a first integrated circuit.

3. The duplex signal communication channel of claim 1, wherein the first and second signal transmission lines comprise metal traces on a printed circuit board.

4. The duplex signal communication channel of claim 1, wherein the duplex communication channel forms a portion of a cable.

5. The duplex signal communication channel of claim 1, wherein the common clock frequency is in the radio-frequency (RF) range.

6. The duplex signal communication channel of claim 1, wherein the multiple is 2.

7. A data processing system, comprising:
a processor;
a duplex signal communication channel communicatively coupled to the processor, the duplex signal communication channel including:
first and second signal transmission lines;
a first amplifier and a first receiver circuit coupled by the first signal transmission line;
a second amplifier and a second receiver circuit coupled by the second signal transmission line;
wherein:
the first amplifier is operative in a nonlinear operation region to transmit a first data signal on the first signal transmission line at a multiple of a common clock frequency, wherein the multiple is greater than 1;
the second amplifier is operative to transmit a second data signal on the second signal transmission line at the common clock frequency concurrently with transmission of the first data signal;
the first receiver circuit includes a frequency divider circuit operative to extract the first data signal from the first signal transmission line; and
the second receiver circuit is operative to receive the second data signal on the second signal transmission line.

8. The data processing system of claim 7, wherein the first amplifier and the second receiver circuit form a portion of a first integrated circuit.

9. The data processing system of claim 7, wherein the first and second signal transmission lines comprise metal traces on a printed circuit board.

10. The data processing system of claim 7, further comprising a cable including duplex signal communication channel.

11. The data processing system of claim 7, wherein the common clock frequency is in the radio-frequency (RF) range.

12. The data processing system of claim 7, wherein the multiple is 2.

13. The data processing system of claim 7, wherein the processor comprises a quantum processor.

14. A method of data communication via a duplex signal communication channel including first and second signal transmission lines, the method comprising:
while driving a first amplifier coupled to the first signal transmission line into a nonlinear region of operation, transmitting, by the first amplifier, a first data signal on the first signal transmission line, wherein the first data signal is transmitted at a multiple of a common clock frequency, wherein the multiple is greater than 1;
transmitting, by a second amplifier coupled to the second signal transmission line, a second data signal on the second signal transmission line concurrently with transmission of the first data signal, wherein the second data signal is transmitted at the common clock frequency;
receiving, by a first receiver circuit, the first data signal, wherein the receiving includes extracting the first data signal from the first signal transmission line utilizing a frequency divider circuit; and
receiving, by a second receiver circuit, the second data signal on the second signal transmission line.

15. The method of claim 14, wherein the first amplifier and the second receiver circuit form a portion of a first integrated circuit.

16. The method of claim 14, wherein the first and second signal transmission lines comprise metal traces on a printed circuit board.

17. The method of claim 14, wherein the duplex communication channel forms a portion of a cable.

18. The method of claim 14, wherein the common clock frequency is in the radio-frequency (RF) range.

19. The method of claim 7, wherein the multiple is 2.
